(19) United States
(12) Patent Application Publication
(10) Pub. No.: US 2023/0002248 A1
(43) Pub. Date: Jan. 5, 2023

(54) MOBILE WATER PURIFICATION SYSTEM

(71) Applicant: Aqua Blue Water Purification Specialists, Inc., Lomita, CA (US)

(72) Inventor: Parviz Mehr, Lomita, CA (US)

(21) Appl. No.: 17/856,638

(22) Filed: Jul. 1, 2022

Related U.S. Application Data
(60) Provisional application No. 63/217,614, filed on Jul. 1, 2021.

(51) Int. Cl. C02F 1/18; C02F 1/28; C02F 1/32

(52) U.S. Cl. CPC C02F 1/18; C02F 1/283; C02F 1/32; C02F 2201/001

(57) ABSTRACT

A mobile water purification system comprises a movable trailer, a storage tank positioned within the trailer, a water filtration and treatment system positioned at least partially within the trailer, a water dispensing system positioned at least partially within the trailer. and one or more solar panels coupled to the trailer.

### CROSS-REFERENCE TO RELATED APPLICATIONS

This application claims priority from and the benefit of U.S. Provisional Patent Application Ser. No. 63/217,614, filed on Jul. 1, 2021, titled “Mobile Water Purification System,” which is hereby incorporated by reference herein in its entirety.

### FIELD OF THE INVENTION

The present invention relates generally to water purification systems, and more specifically, to a mobile solar-powered water purification and dispensing system.

### BACKGROUND OF THE INVENTION

Many geographical locations do not provide people with a clean source of water that can be used for drinking, cleaning, washing clothes, etc. It can be difficult to transport filtering and treatment equipment to these locations in order to filter and treat the water that is present. Further, many of these locations are remote, so it can be hard to provide power to any equipment that is transported to these locations. Thus, new systems and devices are needed to provide a clean source of water to these locations.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

Aspects of the present disclosure are directed to a mobile water purification system. In some implementations, the mobile water purification system comprises a movable trailer; a storage tank positioned within the trailer; a water filtration and treatment system positioned at least partially within the trailer; a water dispensing system positioned at least partially within the trailer; and one or more solar panels coupled to the trailer.

In some implementations, the water filtration and treatment system includes one or more filters configured to remove undesirable matter from the water.

In some implementations, the water filtration and treatment system includes (i) a screening filter, (ii) a sand filter, (iii) a sediment filter, (iv) a carbon filter, (v) a water softener, (vi) a reverse osmosis filter, (vii) a granular activated carbon (GAC) filter, (viii) an ultraviolet (UV) filter, or (ix) any combination of (i)-(viii).

In some implementations, wherein the water dispensing system includes one or more pumps, a tubing system, and one or more faucets.

In some implementations, the water filtration and treatment system includes a first portion and a second portion.

In some implementations, the tubing system includes a first portion fluidly coupling the first portion of the water filtration and treatment system to a water source.

In some implementations, an end of the first portion of the tubing system is configured to be disposed within a natural water source to fluidly couple the first portion of the water filtration and treatment system to the natural water source.

In some implementations, an end of the first portion of the tubing system is configured to be coupled to an artificial water source to fluidly couple the first portion of the water filtration and treatment system to the water source.

In some implementations, the tubing system includes a second portion fluidly coupling the first portion of the water filtration and treatment system to the storage tank.

In some implementations, the tubing system includes a third portion fluidly coupling the storage tank to a second portion of the water filtration and treatment system.

In some implementations, wherein the tubing system includes a fourth portion fluidly coupling the second portion of the water filtration system to the one or more faucets.

In some implementations, the first portion of the water filtration and treatment system includes a screening filter, a sand filter, a sediment filter, a carbon filter, a water softener, and a reverse osmosis filter; and the second portion of the water filtration and treatment system includes a granular activated carbon (GAC) filter and an ultraviolet (UV) filter.

In some implementations, (i) at least one of the one or more pumps, (ii) at least a portion of the tubing system, (iii) at least one of the one or more faucets, or (iv) any combination of (i)-(iii) are formed from food-grade material.

In some implementations, the one or more solar panels are configured to generate electricity usable by the system.

In some implementations, the generated electricity directly powers one or more portions of the water filtration and treatment system, one or more portions of the water dispensing system, or both.

In some implementations, the system includes one or more batteries disposed in the movable trailer. The one or more batteries are configured to store at least a portion of the generated electricity.

In some implementations, the one or more solar panels are movable coupled to the trailer, such that the solar panels can be moved between different positions relative to the trailer.

In some implementations, the water dispensing system includes: one or more faucets; and one or more tubes fluidly coupling the one or more faucets to the storage tank, wherein the one or more faucets are configured to be removably stored within the trailer.

In some implementations, the trailer includes one or more wheels, and is configured to be removably coupled to a vehicle.

In some implementations, (i) the storage tank, (ii) at least a portion of the water dispensing system, or (iii) any combination of (i) and (ii) are formed from food-grade material.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a block diagram of a mobile system for water purification and dispensing, according to aspects of the present disclosure.

FIG. 2A is a first implementation of the system of FIG. 1, according to aspects of the present disclosure.

FIG. 2B is a second implementation of the system of FIG. 1, according to aspects of the present disclosure.

FIG. 2C is a third implementation of the system of FIG. 1, according to aspects of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

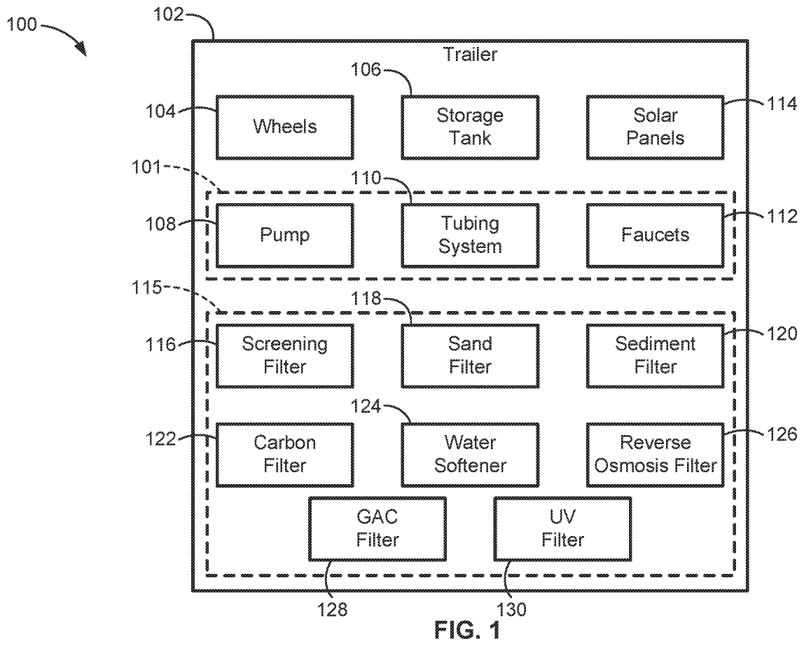

FIG. 1 shows a mobile water purification and dispensing system 100. In the illustrated implementation, system 100 is implemented on a trailer 102 that includes at least one set of wheels 104, so that the trailer 102 can travel around on the wheels 104 to any desired location. The trailer 102 can be connected to a vehicle, such as a truck, SUV, etc., so that the trailer 102 can be towed to the desired location. In some implementations, the trailer 102 has a width of about 6 feet (2 meters), a length of about 8 feet (2.7 meters), and a height of about 6 feet (2 meters).

The system 100 further includes a storage tank 106, a pump 108, a tubing system 110, and one or more faucets (or spigots) 112 that can be stored within the trailer. The pump 108, the tubing system 110, and the faucets 112 can form a water dispensing system 101 that is fluidly coupled to the storage tank 106. Water from any source (such as a well, a river, a lake, a pond, a stream, floodwater, external spigots or faucets, rainwater, etc.) can be stored in the storage tank 106. The storage tank 106 can have any suitable capacity, and may be selected based on the size of the trailer. The system 100 is able to dispense about 2,000 gallons per day, or about 7,570 liters. In some implementations, the storage tank 106 has a capacity of about 2,000 gallons, or about 7,570 liters. In other implementations, the storage tank 106 has a smaller capacity, but can be re-filled one or more times per day.

The tubing system 110 is fluidly coupled to at least the storage tank 106, the pump 108, and the faucets 112. The pump 108 can be operated to transport the water through the tubing system 110, from the storage tank 106 to the faucets 112. The faucets 112 are positioned at the end of the tubing system 110, where users of the system 100 can access the water. The pump 108 can include any suitable type of pump, and can include one pump or a plurality of pumps. In some implementations, the pump 108 is a ¾ horsepower pump. The tubing system 110 can include any number of tubes in any length as required to transport water through the system 100 to the faucets 112. The tubes can be plastic, metal, or any other suitable material. The faucets 112 can include any suitable number of faucets. In some implementations, faucets 112 includes four faucets spaced apart so that four different people can simultaneously use the system 100.

The system 100 further includes a solar panel 114 that is attached to the trailer 102. The solar panel 114 converts sunlight into electrical energy that is used to power various components of the system 100, including the pump 108. The electrical energy produced by the solar panel 114 can directly power the components of the system 100, but can additionally or alternatively be stored in one or more batteries that may be located on the trailer 102. In some implementations, the solar panel 114 has a generally rectangular shape, with a first dimension of about 9 feet (3 meters), and a second dimension of about 12 feet (3.7 meters). The solar panel 114 is able to produce enough electricity to power the system 100. In some implementations, the solar panel 114 is a 5 kW solar panel, and the system 100 uses about 5 kilowatt-hours of electricity per day.

In some implementations, the solar panel 114 is movably attached to the trailer 102, so that the solar panel 114 can move between a stowed position and a deployed position. The solar panel 114 can be moved to the stowed position when the system 100 is being transported (e.g., when the trailer 102 is attached to a vehicle and towed to a desired location), and then moved to the deployed position once the system 100 is in the desired location. In the stowed position, the solar panel 114 is positioned generally horizontal on top of the trailer 102. In the deployed position, the solar panel 114 is generally extended away from the top of the trailer 102, and is positioned at an angle relative to the top of the trailer 102. In the deployed position, the solar panel 114 is positioned at a desired angle such that as much sunlight is possible is incident on the solar panel 114 at a desired angle. In some implementations, the solar panel 114 is attached to the trailer 102 via telescoping rods that are extended to move the solar panel 114 to the deployed position. The solar panel 114 can be rotatably attached to distal ends of the telescoping rods to allow the angle of the solar panel 114 to be adjusted. In the deployed position, the highest point of the solar panel 114 is about 9 feet (3 meters) high.

In some implementations, the trailer 102 includes one or more motors that can be operated to move the solar panel 114 between the stowed position and the deployed position. The one or more motors can also be operated to move the solar panel 114 through various angles relative to the sunlight when in the deployed position. In some implementations, the one or more motors are operated manually. In some implementations, the one or more motors can be operated automatically. For example, the trailer 102 may include a device that determines the position of the sun in the sky, and causes the one or more motors to move the solar panel 114 to a desired angle relative to the position of the sun. This device (sometimes referred to as a sunfinder or a solar tracker) can include a GPS unit and one or more processing devices. In some implementations, the one or more motors are incorporated into the device. In some implementations, the device includes one or more actuators (such as hydraulic cylinders) that can be operated to move the solar panel 114. In some implementations, the weight of the trailer 102 and the solar panel 114 is about 2,000 kg (about 4,444 pounds). The system 100 generally includes one or more batteries to store electrical energy generated by the solar panel 114. Further, while generally referred to as a singular solar panel 114, solar panel 114 may actually be a plurality of solar panels.

In some implementations, the solar panel includes a tracking mechanism that can track the position of the sun and automatically move the solar panel to track the sun. The tracking mechanism can be an active tracking mechanism or a passive tracking mechanism. An active tracking mechanism includes a mechanical structure driven by a motor, and one or more sensors. The solar panel is mounted on the mechanical structure, and when the sensors detect the position of the sun, the motor can be driven to move the solar panel to track the sun. A passive tracking mechanism can use a gas system to move the solar panel. The solar panel is mounted on a mechanical structure that is filled with gas. The gas is heated by the sunlight and expands, which causes the mechanical structure to move the solar panel and track the sun. As the sun moves, the gas cools down and contracts, which again causes the solar panel to move and track the sun. Generally, the tracking mechanism is configured to move the solar panel so that the amount of sunlight that is incident on the solar panel at the desired angle is kept at high levels at all times, or at most of the time.

The system 100 further includes a water filtration and treatment system 115 that is fluidly coupled to some combination of the storage tank 106, the pump 108, the tubing system 110, and the faucets 112. The water filtration and treatment system 115 includes a variety of different filtering and treatment mechanisms used to remove particulate matter, pathogens, chemicals, etc. from the water. In the illustrated implementation, the water filtration and treatment system 115 includes a screening filter 116, a sand filter 118, a sediment filter 120, a carbon filter 122, a water softener 124, a reverse osmosis filter 126, a granular activated carbon (GAC) filter 128, and an ultraviolet (UV) filter 130. These filters are used to remove undesirable solids, particulates, chemicals, etc. from the water source, before being dispensed to users through the faucets 112. In some implementations, the system 100 also includes pre-filters that perform an initial amount of filtering before the water from the source is stored in the storage tank 106. The tubing system 110 is used to transport the water from the storage tank 106, through the water filtration and treatment system 115, and to the faucets 112. The system 100 may include a variety of sealing components (such as o-rings) positioned at the junctions between different components (for example, where tubing connects to one of the filters) to minimize the amount of water lost during use of the system 100.

The water filtration and treatment system 115 is generally compliant with all applicable regulations, including those issued by the U.S. Department of Health and Human Services. In some implementations, the water is retrieved from a source (such as a well, a river, a lake, a pond, a stream, floodwater, external spigots or faucets, rainwater, etc.), and then passed through the filters of the water filtration and treatment system 115. The filtered and treated water can then be stored in the storage tank 106. In other implementations, the storage tank 106 may comprise multiple separate storage tanks. One of these storage tanks is a raw water storage tank that stores water before it is filtered and treated, and the other storage tank is a purified water storage thank that stores water after the water has been filtered and treated. In some implementations, the water passes through a portion of the water filtration and treatment system 115 and is stored in the storage tank 106. Then, as the water is dispensed from the storage tank 106 to the users, the water passes through the rest of the water filtration and treatment system 115.

The screening filter 116 is a mechanical filter designed to filter out larger objects, such as rocks, sticks, branches, leaves, grass, dirt, etc. The screening filter 116 can include a screen with openings large enough to be visible to the human eye. The sand filter 118 includes a volume of sand that the water filters through. In some implementations, the sand filter 118 is a 20-micron sand filter, which may be capable of removing about 85% of material that is 20 microns or larger, or removing about 99.9% of material that is 20 microns or larger.

The sediment filter 120 is generally a mechanical filter formed from a membrane having openings defined therein. The openings are smaller than the individual particles to be filtered out. In some implementations, the sediment filter 120 is a 5-micron filter, which is designed to remove matter that is 5 microns or larger. In some implementations, the 5-micron sediment filter removes about 85% of the matter that is 5 microns or larger. In other implementations, the 5-micron sediment filter removes about 99.9% of the matter that is 5 microns or larger. The sediment filter 120 can be formed from a variety of different materials, such as string, cord, polypropylene, polyester, cellulose, ceramic, glass fiber, cotton, etc. The carbon filter 122 uses carbon to unwanted material from the water. In some implementations, the carbon filter 122 uses charcoal to filter the water.

The water softener 124 is used to remove metal ions from the water, such as calcium and magnesium. In some implementations, the water softener 124 uses ion-exchange materials, which donate sodium ions or potassium ions to the water in exchange for the metal cations. In these implementations, the ion-exchange material can include ion-exchange resin formed into bead shapes. In some of these implementations, the water softener 124 is a duplex system that contains two reservoirs of the ion-exchange material. Only the first reservoir of ion-exchange material is initially used to soften the water, and once the ion-exchange material in the first reservoir is exhausted, the first reservoir can be swapped with the second reservoir. The ion-exchange material in the second reservoir is then used to soften the water while the ion-exchange material in the first reservoir is recharged. The first reservoir and the second reservoir can continue to be alternated in this fashion, such that the water softener 124 does not have to be taken offline. In other implementations, the water softener 124 can uses a variety of different techniques or substances to soften the water, such as lime, chelating agents, washing soda (Na₂CO₃), or distillation techniques.

The reverse osmosis filter 126 uses a partially permeable membrane to separate ions and other molecules from the water. In the reverse osmosis filter 126, the water is forced through a semipermeable membrane, which removes solutes dissolved in the water. The semipermeable membrane generally includes holes that are about 0.0001 microns in diameter. After the water passes through the reverse osmosis filter 126, the water can be storage in the storage tank 106 until it is ready to be dispensed. When the water is dispensed, it passes through the GAC filter 128 and the UV filter 130.

The GAC filter 128 uses granulated activated carbon to remove unwanted material from the water. Generally, the GAC filter 128 is made from organic material that have a high concentration of carbon, such as coconut shells, coal, wood, lignite (sometimes referred to as brown coal), and/or petroleum products. The organic material in the GAC filter 128 will have pores of a certain size that remove material from the water. In some implementations, the GAC filter 128 is a 5-micron GAC filter, which may be capable of removing about 85% of material that is 5 microns or larger, or removing about 99.9% of material that is 5 microns or larger.

The UV filter 130 uses UV light to destroy living organisms in the water, such as bacteria and viruses. The UV filter 130 generally includes a UV lamp housed in a quartz sleeve. The UV light emitted by the UV lamp can have a wavelength in a range of between about 10 nanometers and about 400 nanometers. In some implementations, the UV lamp emits UV-C light, which has a wavelength between about 254 nanometers and about 265 nanometers. In some implementations, the UV lamp emits light that has a wavelength of about 254 nanometers. The UV light has sufficient energy to destroy any living organisms in the water, so that the organisms cannot reproduce and spread in the water. Example organism that can be destroyed using the UV filter 130 include Cryptosporidium, Giardia, dysentery bacilli, Salmonella, Mycobacterium tuberculosis, Streptococcus, E. coli, hepatitis B, cholera, algae, fungi, and some viruses.

In some implementations, the tubing system 110 includes a variety of different portions that fluidly couple together different components of the system 100. A first portion of the tubing system 110 can be fluidly coupled to a first portion of the water filtration and treatment system 115. One end of the first portion of the tubing system 110 can be immersed in the water of the water source (e.g., into a river or a lake), while the other end of the first portion of the tubing system 110 is coupled to the first portion of the water filtration and treatment system 115. In turn, the first portion of the water filtration and treatment system 115 can be fluidly coupled to the storage tank 106 via a second portion of the tubing system 110, and the storage tank 106 can be fluidly coupled to a second portion of the water filtration and treatment system 115 via a third portion of the tubing system 110. Thus, water from the water source travels through the first portion of the water filtration and treatment system 115 before being stored in the storage tank 106. This water then travels through the second portion of the water filtration and treatment system 115 before being dispensed.

The first portion of the water filtration and treatment system 115 can include the screening filter, the sand filter 118, the sediment filter 120, the carbon filter 122, the water softener 124, and the reverse osmosis filter 126. The second portion of the water filtration and treatment system 115 can include the GAC filter 128 and the UV filter 130. The second portion of the water filtration and treatment system 115 is fluidly coupled to the faucets 112 via a fourth portion of the tubing system 110. The pump 108 can be fluidly coupled in-line at any point within the system 100 to pump water through the system 100. In some implementations, pump 108 includes multiple pumps that can be placed at different points within the system 100. In some implementations, the tubing system 110 includes individual tubing segments between each of the components of the first and second portions of the water filtration and treatment system 115, to allow water to flow therethrough. Each portion of the tubing system 110 can include one or more tubes.

The water filtration and treatment system 115 is designed to remove a variety of different matter from the water, such as sand, silt, rust, pathogens (such as bacteria or protozoa), chemicals (including organic chemicals), disinfection byproducts, organic contaminants (such as chlorinated solvents), pesticides, arsenic, lead, mercury, chromium, copper, uranium, and other materials.

The trailer 102 may include any combination of the illustrated components of the water filtration and treatment system 115. For example, in some implementations the trailer 102 includes the screening filter 116, and the sand filter 118, and the sediment filter 120. In other implementations, the trailer 102 may include these components, as well as the carbon filter 122, the water softener 124, the GAC filter 128, and the UV filter 130. In further implementations, the trailer 102 further includes the reverse osmosis filter 126. In some implementations, the water filtration and treatment system 115 may include additional chemicals that can be added to the water, such as chemicals that cause smaller particles within the water to stick together and form larger particles, which are then more easily filtered out of the water.

The system 100 can be adapted to collect water from a variety of sources. For example, in some implementations, the first portion of the tubing system 110 can be used to collect water simply by placing an end of the first portion of the tubing system 110 into a natural water source (e.g., into a well, a river, a lake, a pond, a stream, floodwater etc.). In other implementations, the end of the first portion of the tubing system 110 can be coupled to an artificial water source (such as a faucet or spigot), for example by screwing onto the faucet. In some implementations, the tubing system 110 may have multiple first portions, where one is used to collect water from a natural water source and another is used to collect water from an artificial water source. In other implementations, the tubing system 110 may only have a single first portion, which can be placed into a natural water source (e.g., into a well, a river, a lake, a pond, a stream, floodwater etc.), but also coupled to an artificial water source that may require such coupling (such as a faucet or a spigot). The system 100 may also include additional components that aid in collecting water from other sources. For example, the system 100 may include a plurality of basins that can be used to collect rainwater. The basins can be fluidly coupled to the first portion of the tubing system 110, the additional portion of the tubing system 110 (if such additional portion of the tubing system 110 exists), and/or the first portion of the water filtration and treatment system 115.

In some implementations, the system 100 can also include storage for a variety of different components, including filters, replacement parts, etc. This storage can be formed on the trailer 102. In some implementations, the trailer 102 also stores components needed for real-time monitoring of the system 100, and testing of the water after it travels through the water filtration and treatment system 115. For example, the system 100 can include a pH meter to test the pH of the water, and various materials to adjust the pH of the water may also be stored directly on the trailer 102 itself. The system 100 may also include a variety of drainage component designed to catch any water that exits the faucets 112 but is inadvertently not collected by the users. The system 100 could also include an electronic chlorine dosing pump to provide residual post-treatment disinfection of the water. The system 100 can also include an automated backwash function that ensures timely cleaning of the various filters in the water filtration and treatment system 115. The backwash system flows water through the water filtration and treatment system 115 in reverse order to clean the filters. The backwash interval can be adjusted based on the quality of the source water.

In some implementations, all of the components of the system 100 that come into contact with water are formed from food-grade materials. In some implementations, the food-grade material includes silicone, nylon, acetal, polyethylene, polypropylene, polyvinyl chloride, polyvinylidene fluoride, or combinations thereof. Other materials can also be used. In some implementations, any components of the system 100 that comes into contact with the water after the water has been fully filtered and treated (e.g., after the water has passed through all of the filters and the water softener) are made from food-grade materials. In these implementations, any portion of the storage tank 106, the pump 108, at least a portion of the tubing system 110, and the faucets 112 can be made from food-grade material.

In operation, the trailer 102 can be towed to a suitable source of water and parked, where the solar panel 114 is deployed. Water can begin to be collected from the source and stored in the storage tank 106. Generally, between about 30 minutes and 2 hours elapses until enough water has been collected, and the water filtration and treatment system 115 can be activated. The treatment process generally takes a maximum of about 1 hour before the filtered and treated water can be dispensed through the faucets 112. The maximum flow rate of water through the faucets 112 is about 1.5 gallons per minutes. The maximum amount of water that can be filtered and dispensed is about 2,000 gallons per day.

In some implementations, the system 100 can include additional or alternative energy sources. For example, the system could include any number of small wind turbines/fans that can convert wind to electrical energy. The system could also include any number of small water turbines that convert moving water to electrical energy. Water turbines may be particularly useful if the system 100 is deployed near a river. In still other implementations, the system 100 could include components necessary for manual production of energy, such as a human-operated crank. In any of these implementations, the system 100 may include one or more small electromagnetic generators that can be coupled to the turbines (or the human-operated crank) to produce the electrical energy.

In some implementations, one or more of the components of the system 100 can be removable from the trailer 102 itself. For example, the pump 108, the faucets 112, and at least a portion of the tubing system 110 can be removed from the trailer 102 and positioned outside of the trailer 102 when the system 100 is operation. This allows users to dispense water at the faucets 112 without actually entering the trailer 102.

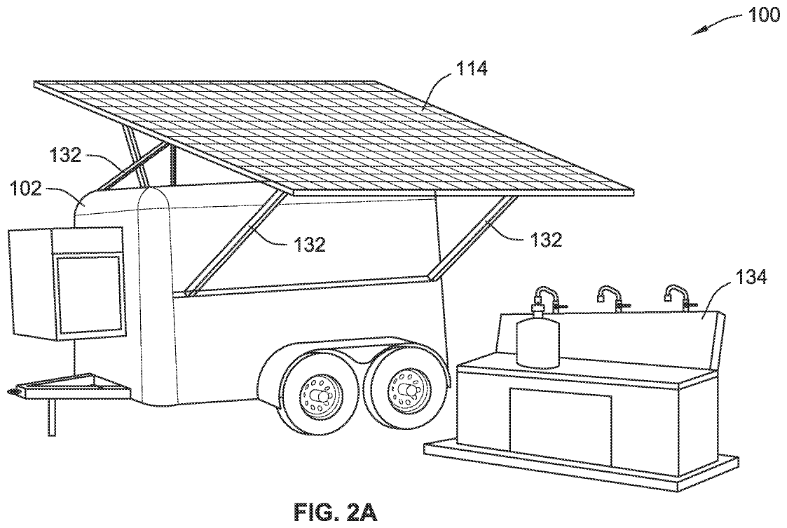

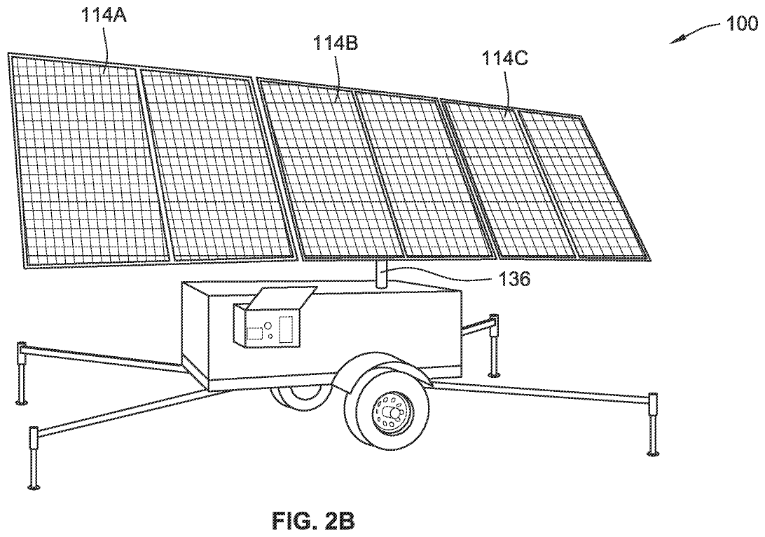

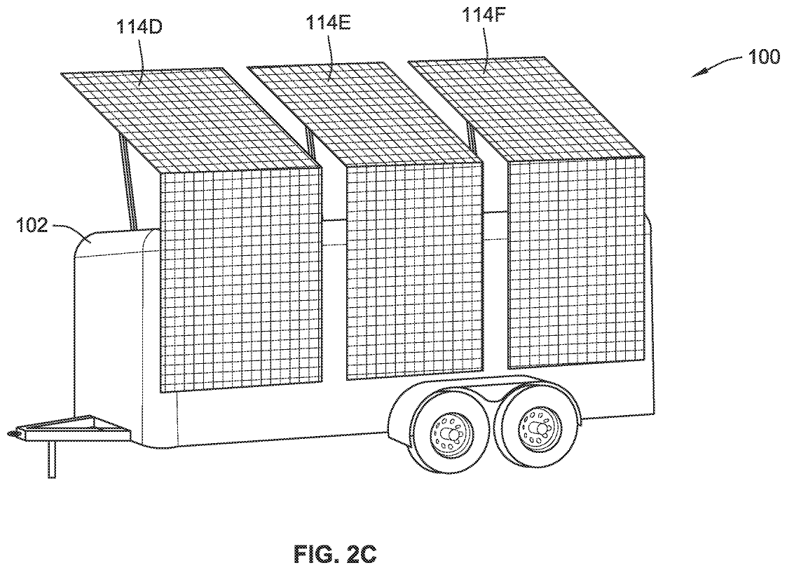

FIGS. 2A-2C illustrate different implementations of the system 100. In FIG. 2A, the system 100 includes a single solar panel 114 mounted onto the trailer 102 via telescoping rods 132. FIG. 2A also illustrates a dispensing housing 134, which can house at least a portion of the water dispensing system 101. In the illustrated implementation, the dispensing housing 134 houses the faucets 112 and at least a portion of the tubing system 110. The dispensing housing 134 can also house the pump 108, and in some implementations some portion of the water filtration and treatment system 115. In FIG. 2B, the system 100 includes three different solar panels 114A, 114B, and 114C mounted to the trailer 102 via a single mounting post 136. In FIG. 2C, the system includes three different solar panels 114D, 114E, and 114F that extend both on one side of the trailer 102, and above the top of the trailer 102.

Thus, system 100 provides a mobile, solar-powered water purification, treatment, and dispensing system that can provide clean water for multiple users. The system 100 allows for easy collection and purification of the water via the storage tank and the water filtration and treatment system 115, which includes a multi-stage purification system. The system 100 also include multiple faucets for easy dispensing to multiple users, which allows water to be collected and used for a variety of purposes, including washing, rinsing, filling of drinking containers, etc. All of the components needed for the collection, purification, and dispensing of the water can be contained within a trailer that can be towed to any desirable location.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A mobile water purification system, comprising:
a movable trailer;
a storage tank positioned within the trailer;
a water filtration and treatment system positioned at least partially within the trailer;
a water dispensing system positioned at least partially within the trailer; and
one or more solar panels coupled to the trailer.

2. The system of claim 1, wherein the water filtration and treatment system includes one or more filters configured to remove undesirable matter from the water.

3. The system of claim 2, wherein the water filtration and treatment system includes (i) a screening filter, (ii) a sand filter, (iii) a sediment filter, (iv) a carbon filter, (v) a water softener, (vi) a reverse osmosis filter, (vii) a granular activated carbon (GAC) filter, (viii) an ultraviolet (UV) filter, or (ix) any combination of (i)-(viii).

4. The system of claim 1, wherein the water dispensing system includes one or more pumps, a tubing system, and one or more faucets.

5. The system of claim 4, wherein the water filtration and treatment system includes a first portion and a second portion.

6. The system of claim 5, wherein the tubing system includes a first portion fluidly coupling the first portion of the water filtration and treatment system to a water source.

7. The system of claim 6, wherein an end of the first portion of the tubing system is configured to be disposed within a natural water source to fluidly couple the first portion of the water filtration and treatment system to the natural water source.

8. The system of claim 6, wherein an end of the first portion of the tubing system is configured to be coupled to an artificial water source to fluidly couple the first portion of the water filtration and treatment system to the natural water source.

9. The system of claim 6, wherein the tubing system includes a second portion fluidly coupling the first portion of the water filtration and treatment system to the storage tank.

10. The system of claim 9, wherein the tubing system includes a third portion fluidly coupling the storage tank to a second portion of the water filtration and treatment system.

11. The system of claim 10, wherein the tubing system includes a fourth portion fluidly coupling the second portion of the water filtration system to the one or more faucets.

12. The system of claim 5, wherein:
the first portion of the water filtration and treatment system includes a screening filter, a sand filter, a sediment filter, a carbon filter, a water softener, and a reverse osmosis filter; and
the second portion of the water filtration and treatment system includes a granular activated carbon (GAC) filter and an ultraviolet (UV) filter.

13. The system of claim 4, wherein (i) at least one of the one or more pumps, (ii) at least a portion of the tubing system, (iii) at least one of the one or more faucets, or (iv) any combination of (i)-(iii) are formed from food-grade material.

14. The system of claim 1, wherein the one or more solar panels are configured to generate electricity usable by the system.

15. The system of claim 14, wherein the generated electricity directly powers one or more portions of the water filtration and treatment system, one or more portions of the water dispensing system, or both.

16. The system of claim 15, further comprising one or more batteries disposed in the movable trailer, the one or more batteries being configured to store at least a portion of the generated electricity.

17. The system of claim 1, wherein the one or more solar panels are movable coupled to the trailer, such that the solar panels can be moved between different positions relative to the trailer.

18. The system of claim 1, wherein the water dispensing system includes:
one or more faucets; and
one or more tubes fluidly coupling the one or more faucets to the storage tank,
wherein the one or more faucets are configured to be removably stored within the trailer.

19. The system of claim 1, wherein (i) the storage tank, (ii) at least a portion of the water dispensing system, or (iii) any combination of (i) and (ii) are formed from food-grade material.

20. The system of claim 1, further comprising one or more basins coupled to the movable trailer, the one or more basins being configured to collect rainwater.
